(19) United States
(12) Patent Application Publication
(10) Pub. No.: US 2020/0172041 A1
(43) Pub. Date: Jun. 4, 2020

(54) VEHICLE WITH DEPLOYABLE ENERGY ABSORBING DEVICE

(71) Applicant: Nissan North America, Inc., Franklin, TN (US)

(72) Inventor: Jeffery DIX, Commerce, MI (US)

(73) Assignee: Nissan North America, Inc.

(21) Appl. No.: 16/206,374

(22) Filed: Nov. 30, 2018

(51) Int. Cl. B60R 21/21; B60R 21/237; B60R 21/235; B60R 21/231; B60R 21/36

(52) U.S. Cl. CPC B60R 21/21; B60R 21/237; B60R 2021/0006; B60R 21/23138; B60R 21/36; B60R 21/235

(57) ABSTRACT

A vehicle that includes a vehicle body structure and a deployable energy absorbing device. The vehicle body structure defines a vehicle longitudinal direction and has an opening along a lateral exterior side thereof. The opening exposes a hollow interior of the vehicle body structure. The vehicle body structure has a structural member that extends parallel to the vehicle longitudinal direction within the hollow interior inboard of the opening. The deployable energy absorbing device has a deployable member, the deployable energy absorbing device being supported to the structural member of the vehicle body structure within the hollow interior. The deployable energy absorbing device is concealed within the hollow interior in the stowed orientation. The deployable member extends laterally outward perpendicular to the vehicle longitudinal direction and away from the structural member and a lateral exterior side of the vehicle body structure in a deployed orientation.

### BACKGROUND

### Field of the Invention

The present invention generally relates to a vehicle with a deployable energy absorbing device. More specifically, the present invention relates to a deployable energy absorbing device that is concealed within a hollow area within the vehicle in a stowed orientation. In a deployed orientation, the deployable energy absorbing device extends laterally outward perpendicular to a vehicle longitudinal direction away from in an outboard direction away from a lateral exterior side of the vehicle.

### Background Information

Vehicles are required to include airbag devices located within a vehicle that deploy within a passenger compartment of the vehicle.

### SUMMARY

On object of the present disclosure is to provide a vehicle with a deployable energy absorbing device that is concealed within a hollow area within the vehicle in a stowed orientation, and, in a deployed orientation, the deployable energy absorbing device extends laterally outward perpendicular to a vehicle longitudinal direction in an outboard direction away from a lateral exterior side of the vehicle.

In view of the state of the known technology, one aspect of the present disclosure is to provide a vehicle with a vehicle body structure and a deployable energy absorbing device. The vehicle body structure defines a vehicle longitudinal direction. The vehicle body structure also has an opening along a lateral exterior side thereof. The opening exposes a hollow interior of the vehicle body structure. The vehicle body structure has a structural member that extends parallel to the vehicle longitudinal direction within the hollow interior inboard of the opening. The deployable energy absorbing device has a deployable member. The deployable energy absorbing device is supported to the structural member of the vehicle body structure within the hollow interior. The deployable energy absorbing device is concealed within the hollow interior in the stowed orientation. The deployable member extends laterally outward perpendicular to the vehicle longitudinal direction and away from the structural member and a lateral exterior side of the vehicle body structure in a deployed orientation.

### BRIEF DESCRIPTION OF THE DRAWINGS

Referring now to the attached drawings which form a part of this original disclosure:

FIG. 1 is a perspective view of a vehicle that includes a vehicle body structure and a deployable energy absorbing device that is concealed behind a trim member in a stowed orientation in accordance with a first embodiment;

FIG. 2 is another perspective view of the vehicle showing the deployable energy absorbing device in a deployed orientation extending through an opening in the vehicle body structure, where the vehicle body structure is a door, in accordance with a first embodiment;

FIG. 3 is a perspective view of the door removed from the vehicle in accordance with the first embodiment;

FIG. 4 is an exploded perspective view of the door depicted in FIG. 3, showing an exterior trim panel, an outer panel, the deployable energy absorbing device, a structural member and an inner panel, in accordance with the first embodiment;

FIG. 5 is a cross-sectional view of the door taken along the line 5-5 in FIG. 3, showing the outer panel and the inner panel defining a hollow interior space therebetween, with the structural member and the deployable energy absorbing device installed to the door within the hollow interior space, in accordance with the first embodiment;

FIG. 6 is a cross-sectional view taken along the line 6-6 in FIG. 5, showing in solid lines a deployable member of the deployable energy absorbing device in a stowed orientation within the hollow interior space of the door, and showing in phantom lines the deployable member of the deployable energy absorbing device partially deployed moving toward the deployed orientation with a portion of the deployable member extending through the opening in the door and expanding outboard of the door from the hollow interior space in accordance with the first embodiment;

FIG. 7 is a block diagram of an electronic control system that operates the deployable energy absorbing device, showing an electronic controller connected to the deployable energy absorbing device, a speed sensor of the vehicle and movement detection sensors in accordance with the first embodiment;

FIG. 8 is a flowchart showing basic steps of operation conducted by the electronic controller depicted in FIG. 8, in accordance with the first embodiment;

FIG. 9 is a schematic view of the vehicle with movement detection sensors sensing movement of a second vehicle as the second vehicle approaches the vehicle in accordance with the first embodiment;

FIG. 10 is a cross-sectional view similar to FIG. 6, showing a deployable member of a deployable energy absorbing device in a stowed orientation within the hollow interior space of the door, in accordance with a second embodiment;

FIG. 11 is another cross-sectional view similar to FIG. 10 showing the deployable member of the deployable energy absorbing device partially deployed moving toward the deployed orientation with a portion of the deployable member extending through the opening in the door and expanding outboard of the door from the hollow interior space in accordance with the second embodiment;

FIG. 12 is a perspective view of a vehicle that includes a deployable energy absorbing device that is concealed within a sill structure in a stowed orientation in accordance with a third embodiment;

FIG. 13 is another perspective view of the vehicle showing the deployable energy absorbing device in the deployed orientation extending through an opening in the sill structure, in accordance with a third embodiment;

FIG. 14 is a cross-sectional view taken along the line 14-14 in FIG. 12, showing a deployable member of the deployable energy absorbing device in a stowed orientation within the hollow interior space of the door, in accordance with the third embodiment; and

FIG. 15 is another cross-sectional view similar to FIG. 14 showing the deployable member of the deployable energy absorbing device partially deployed moving toward the deployed orientation with a portion of the deployable member extending through the opening in the sill structure and expanding outboard of the sill structure from the hollow interior space in accordance with the third embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

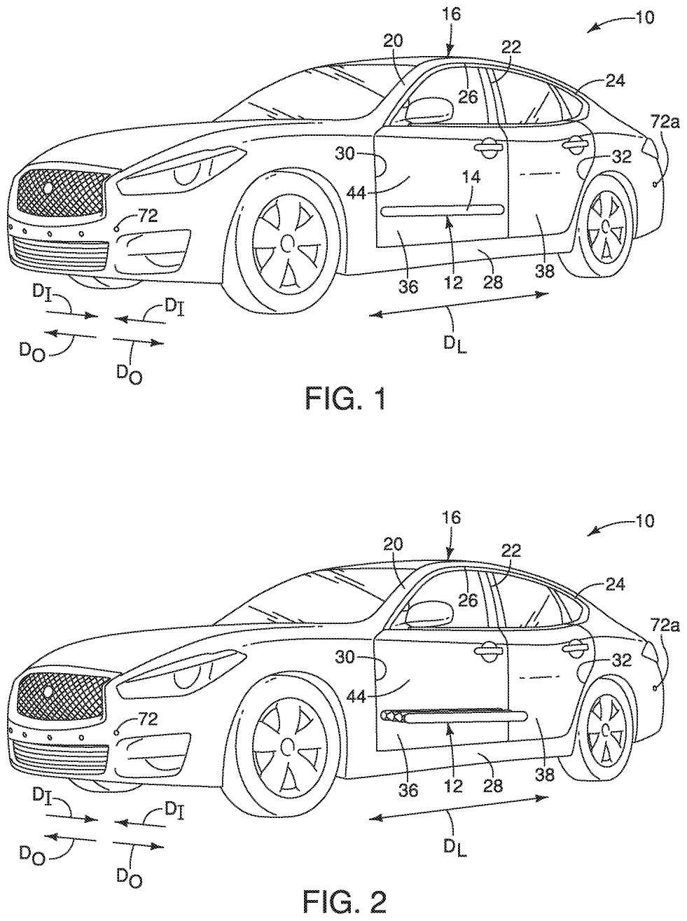

Referring initially to FIG. 1, a vehicle 10 having a deployable energy absorbing device 12 concealed by an elongated trim panel 14 is illustrated in accordance with a first embodiment. The deployable energy absorbing device 12 is configured such that upon deployment, the deployable energy absorbing device 12 extends laterally outboard of a side surface of the vehicle 10, as shown in FIG. 2, thereby providing a impact energy absorbing effect during a side impact event.

The vehicle 10 has a vehicle body structure 16 that includes at least an A-pillar 20, a B-pillar 22, a C-pillar 24, a roof rail 26 and a sill structure 28. The A-pillar 20, the B-pillar 22, a forward section of the roof rail 26 and a forward section of the sill structure 28 together surround and define a front door opening 30. The B-pillar 22, the C-pillar 24, a rearward section of the roof rail 26 and a rearward section of the sill structure 28 together surround and define a rear door opening 32. As shown in FIG. 1, the vehicle 10 and the vehicle body structure 16 define a vehicle longitudinal direction D_{L}, vehicle inboard directions D_{I} and vehicle outboard directions D_{O}. The vehicle longitudinal direction D_{L} is defined as a direction relative to the length of the vehicle 10 or directions parallel to the length of the vehicle 10 (front to back and/or back to front). The vehicle inboard directions D_{I} are defined as directions facing the center of the vehicle 10 from laterally outboard locations, or movement laterally inboard toward the center of the vehicle 10. The vehicle outboard directions D_{O} are defined as directions facing away from the center of the vehicle 10 or movement laterally outboard away from the center of the vehicle 10.

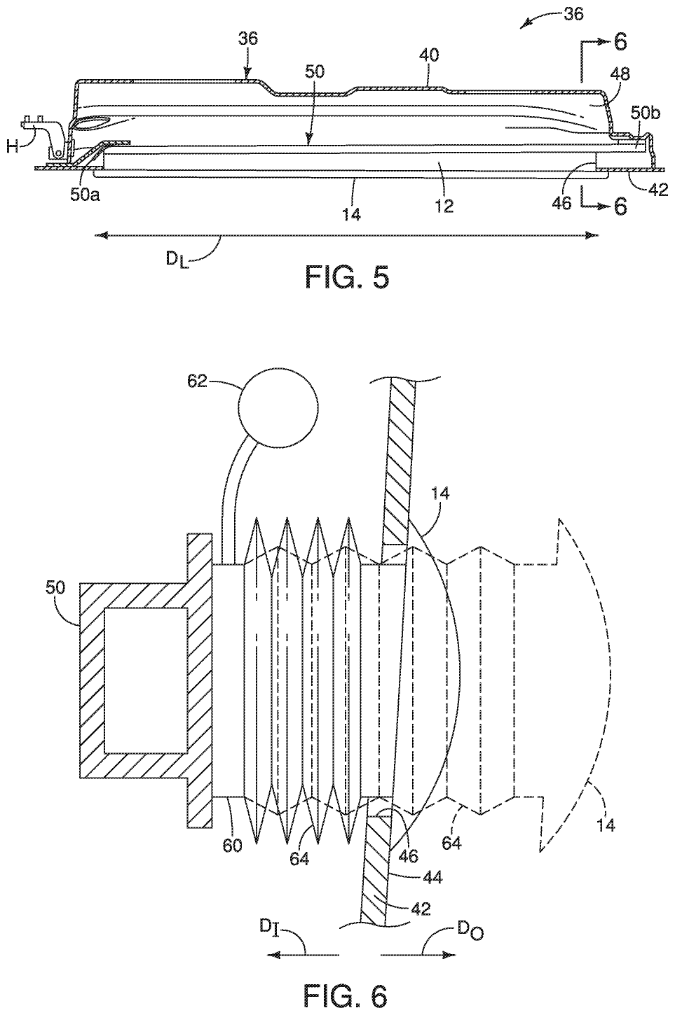

The vehicle 10 further includes a front door 36 and a rear door 38. The front door 36 is pivotally installed to the A-pillar 20 of the vehicle body structure 16 via hinges H (FIG. 5), in a conventional manner, such that the front door 36 covers the front door opening 30 in a closed orientation, as shown in FIG. 1. In the closed orientation, the front door 36 spans the front door opening 30 between the A-pillar 20 and the B-pillar 22. Similarly, the rear door 38 is pivotally installed to the B-pillar 22 of the vehicle body structure 16 via hinges (FIG. 5), in a conventional manner, such that the rear door 38 covers the rear door opening 32 in a closed orientation, as shown in FIG. 1. In the closed orientation, the rear door 38 spans the rear door opening 32 between the B-pillar 22 and the C-pillar 24.

In a first embodiment depicted in FIGS. 1-9, one, or, both of the front door 36 and the rear door 38 can include the deployable energy absorbing device 12. For the sake of brevity, the inclusion of the deployable energy absorbing device 12 within the front door 36 is depicted and described herein below. However, it should be understood from the drawings and the description herein below, that the rear door 38 can also be provided with the deployable energy absorbing device 12. Therefore, description of the front door 36 and the deployable energy absorbing device 12 is equally applicable to the rear door 38.

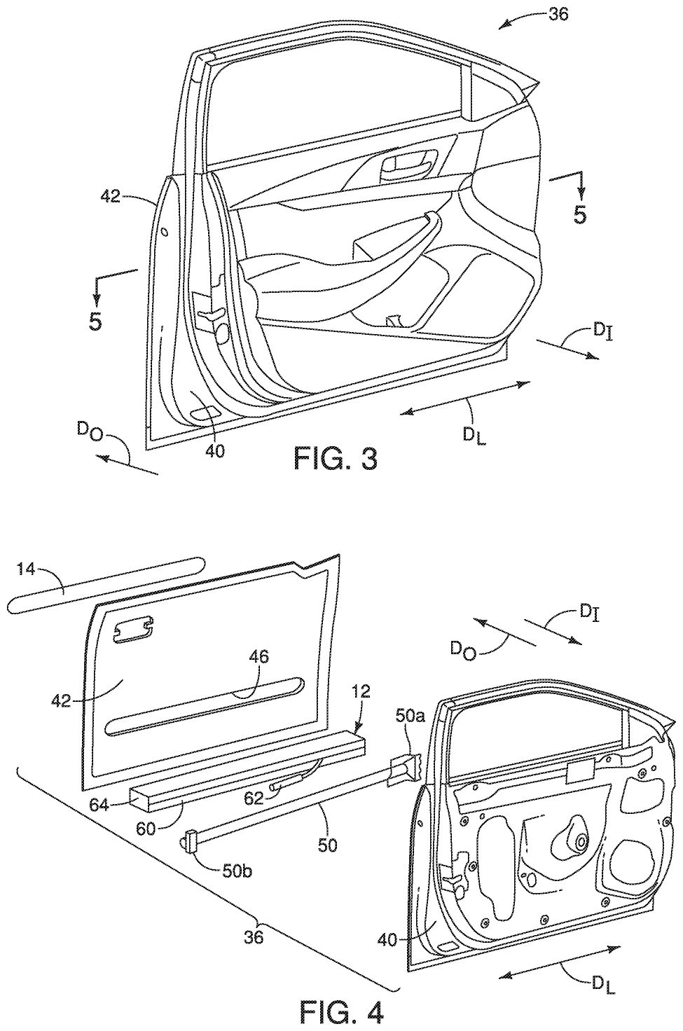

As shown in FIGS. 3-5, the front door 36 includes, among other features and elements, an inner panel 40 (also referred to as an inboard panel) and an outer panel 42 (also referred to as an outboard panel). The outer panel 42 defines a lateral exterior side surface 44 (outboard or outer surface). The outer panel 42 includes an opening 46. The door 36 further defines a hollow interior 48 within the front door 36 between the inner panel 40 and the outer panel 42. The opening 46 exposes the hollow interior 48. Or, put another way, the hollow interior 48 can be accessed from outside the vehicle 10 via the opening 46 in the absence of the deployable energy absorbing device 12.

The inner panel 40 and the outer panel 42 are fixedly attached to one another along respective forward edges, rearward edges and lower edges thereof in a conventional manner. For example, respective forward, rearward and lower edges (peripheral edges) of each of the inner panel 40 and the outer panel 42 can be welded together forming a rigid attachment therebetween in a conventional manner. Since attachments between inner and outer panels of vehicle doors are conventional constructs well known in the art, further description is omitted for the sake of brevity.

The door 36 further includes at least one structural member 50 that extends approximately parallel to the vehicle longitudinal direction D_{L} of the vehicle 10 within the hollow interior 48 of the door 36. The structural member 50 is rigidly fixed at a forward end 50a thereof to a forward portion of the inner panel 40 and the outer panel 42, and at a rearward end 50b is rigidly fixed at a rearward end to at least the inner panel 40 adjacent to the outer panel 42, as shown in FIG. 5. The structural member 50 and the deployable energy absorbing device 12 are installed within the hollow interior 48 of the door 36.

However, it should be understood from the drawings and the description herein that the structural member 50 can be fixed at both forward and rearward ends 50a and 50b to one or both of the inner panel 40 and outer panel 42 within the hollow interior 48. The structural member 50 can be fixedly attached to the inner panel 40 and the outer panel 42 via conventional welding techniques, or via mechanical fasteners. However, in the depicted embodiment, the structural member 50 is fixed to the door 50 by welding techniques.

The structural member 50 is located inboard of the opening 46 and is spaced apart in the inboard direction D_{I} from the outer panel 42, as shown in FIGS. 5 and 6. The structural member 50 is a rigid guard rail or beam that provides further rigidity and structural integrity to the overall structure of the door 36 in the event of a side impact event.

As shown in FIG. 4, the opening 46 in the outer panel 42 of the door 36 is an elongated slot that extends parallel to the vehicle longitudinal direction D_{L}. The opening 46 is also referred to herein below as the elongated slot 46.

As shown in FIGS. 5 and 6, the deployable energy absorbing device 12 includes a base 60, an inflator 62 and a deployable member 64 that are connected to one another. In a stowed orientation, the deployable energy absorbing device 12 is located within the hollow interior 48. The base 60 is basically an attachment bracket that supports the deployable member 64 and provides an attachment structure. The base 60 can serve as a bracket such that the base 60 is supported to the structural member 50. Specifically, the base 60 can be directly fixedly attached to the structural member 50 via, for example, mechanical fasteners or adhesive, or can be indirectly attached to the structural member 50 by intermediary brackets (not shown). The inflator 62 (also referred to as an initiator, trigger or deploying mechanism) is electronically controlled such that upon receiving an electronic signal representing immediate deployment, the inflator 62 causes the deployable member 64 to expand or inflate. An inflation tube is connected at one end to the inflator 62, and at another end to the deployable member 64. The inflator 62 can be a gas filled canister, or can be a canister filled with predetermined chemicals, such that upon receipt of the electronic signal for immediate deployment, the predetermined chemicals are ignited cause rapid production of gas and/or foam that rapidly fills an interior of the deployable member 64, thereby causing the deployable member 64 to rapidly expand and/or inflate.

The deployable member 64 of the deployable energy absorbing device 12 can be any of a variety of deployable devices. For example, the deployable member 64 can be a reinforced airbag, a deployable thermoplastic energy absorber, a folded rubber-like bladder or a metal reinforced device or bag with sides folded in a manner similar to an accordion bellows, as shown in FIG. 6. The deployable member 64 is shown in solid lines in FIG. 6 in a stowed orientation (unused). In the stowed orientation, the deployable member 64 and the base 60 and the inflator 62 are disposed within the hollow interior 48 of the front door 36. The deployable member 64 is also shown in a partially deployed orientation during deployment, in phantom or dashed lines.

During deployment, an expanding gas or expanding foam material is fed into the deployable member 64 via the inflator 62. The deployable member 64 rapidly fills with gas or rapidly expanding foam and moves in the outboard direction D_{I} through the elongated slot 46 and away from the lateral exterior side surface 44 of the outer panel 42. The accordion bellows-like section of the deployable member 64 unfolds as the deployable member 64 expands in the outboard direction D_{I}. Further, during deployment, the deployable member 64 extends laterally outward perpendicular to the vehicle longitudinal direction D_{L} and away from the structural member 50 and the lateral exterior side surface 44 of the vehicle body structure 16.

In the stowed orientation, the exterior trim panel 14 is adhered to one or both of the lateral exterior side surface 44 of the outer panel 42 covering the elongated slot 46 (the opening 46). Upon deployment of the deployable member 64, movement of the deployable member 64 pushes the exterior trim panel 16 away from any attachment to the outer panel 42. If the exterior trim panel 14 is attached (adhered by, for example, an adhesive) to the deployable member 64, then the exterior trim panel 14 moved in the outboard direction Do as shown in FIG. 6. If the exterior trim panel 14 is not fixed to the deployable member 64, then upon deployment of the deployable member 64, the exterior trim panel 14 is pushed away from attachment to the outer panel 42 and falls to the ground.

As shown in FIGS. 5 and 6, in the stowed orientation, the deployable member 50 has an elongated shape that conforms to the shape of the elongated slot 46 and is aligned with the elongated slot 46.

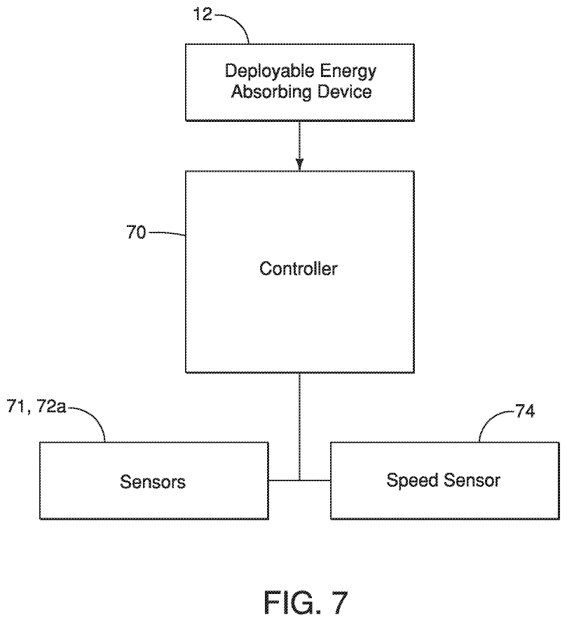

A description of the operation of the deployable energy absorbing device 12 is now provided with specific reference to FIGS. 7, 8 and 9.

FIG. 7 is a block diagram showing an electronic controller 70, movement detection sensors 72 and 72a (sonar or radar sensors), and a speed sensor 74. The electronic controller 70 is in electronic communication with the movement detection sensors 72 and 72a, the speed sensor 74 and the inflator 62 of the deployable energy absorbing device 12.

The electronic controller 70 is preferably a microcomputer that includes one or more processors and one or more computer storage devices (i.e., computer memory devices). The electronic controller 70 is formed of one or more semiconductor chips that are mounted on, for example, a printed circuit board.

Memory associated with the electronic controller 70 is any computer storage device or any computer readable medium with the sole exception of a transitory, propagating signal. For example, the memory of the electronic controller 70 can be nonvolatile memory and volatile memory, and can includes a ROM (Read Only Memory) device, a RAM (Random Access Memory) device, a hard disk, a flash drive, etc..

The electronic controller 70 is programmed to monitor signals from the movement detection sensors 72 and 72a, and the speed sensor 74 and determined whether or not the deployable energy absorbing device 12 is to be deployed. It will be apparent to those skilled in the art from this disclosure that the precise structure and algorithms for the electronic controller 70 can be any combination of hardware and software that will carry out the functions of the present invention.

The movement detection sensors 72 and 72a are conventional sensors, such as sonar or radar sensors that detect either or both movement and proximity of an object. Specifically, the sensors 72 and 72a can be part of a parking sensor array in the bumper facias of the vehicle 10, that are used to assist a vehicle operator when parking the vehicle 10. The sensors 72 and 72a detect the location and speed of an approaching object, or an object that is getting closer to the vehicle 10 as a result of movement of the vehicle 10. In FIGS. 1, 2 and 9, the movement detection sensor 72 is located along a lateral side area of the front bumper fascia, and the movement detection sensor 72a is located along a lateral side area of the rear bumper fascia.

The speed sensor 74 can be connected to a drive train (not shown) of the vehicle 10, the transmission (not shown) or the instrument panel speedometer (not shown) of the vehicle 10. The speed sensor 74 monitors the speed of the vehicle 10 and provides signals to the electronic controller 70 at regular intervals (for example, every 5 to 50 milli-seconds) indicating current speed of the vehicle 10.

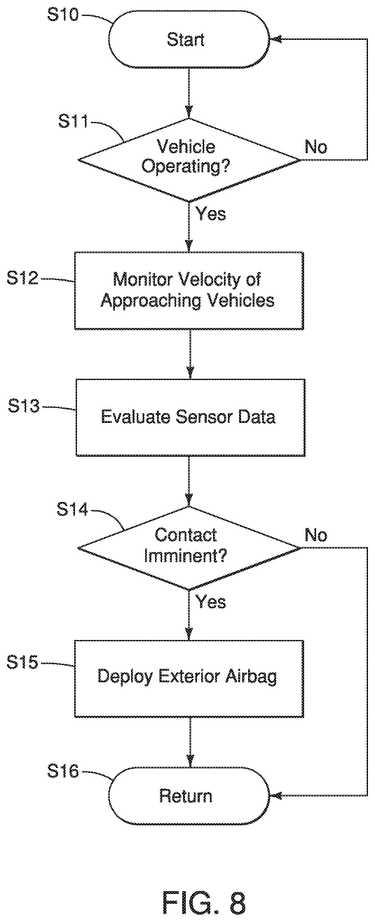

An example of basic logic used by the electronic controller 70 is shown in the flowchart depicted in FIG. 8.

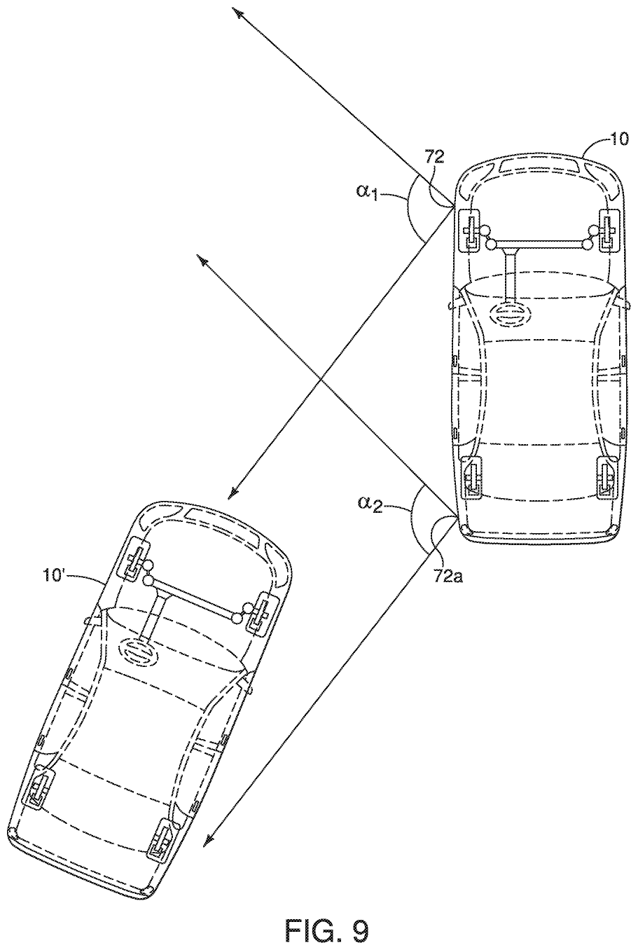

At step S10, the vehicle 10 has been started and the engine is running. At step S11, the electronic controller 70 processes signals from the speed sensor 74 and determines whether or not the vehicle 10 is being driven (is operating and/or is in motion). At step S11, if the vehicle is not operating, and the engine is running, operation returns to step S10. If at step S11, the electronic controller 70 determines that the vehicle 10 is being operated (in motion), then operation moves to step S12. At step S12, the electronic controller 70 monitors and receives signals from the sensors 72 and 72a, and the speed sensor 74. Next at step S13, the electronic controller 70 processes and evaluates the speed signals from the speed sensor 74 and the position and movement of an approaching object, such as another vehicle 10′ shown in FIG. 9. The movement detection sensors 72 and 72a each have a range in which they detect movement and speed of the approaching vehicle 10′. For example, the movement detection sensor 72 detects movement of objects within an angular range defined by an angle α₁. Similarly, the movement detection sensor 72s detects movement of objects within an angular range defined by an angle α₂, as shown in FIG. 7. Each of the sensors 72 and 72a detects movement of objects within a predetermined distance, such as, for example, 100 meters, 200 meters, or any value in between. By processing the signals from the sensors 72 and 72a, and the current speed of the vehicle 10, an approaching trajectory of the vehicle 10′ is calculated by the electronic controller 70.

Next at step S14, the electronic controller 70 then determines whether or not an impact event between the vehicle 10 and the vehicle 10′ is imminent. If no, then operation moves to step S16 and back to step S10. If yes at step S14, then at step S15 the electronic controller 70 sends a signal to the inflator 62 to immediately deploy the deployable member 64.

During an impact event where the electronic controller 70 determines that the vehicle 10′ shown in FIG. 9 is on a trajectory that will result in an impact event with the vehicle 10, the electronic controller 70 causes the deployable member 64 to move to the deployed orientation shown in FIG. 2. It should be understood from the drawings and the description herein, that the inflator 62 (trigger mechanism) acts almost instantly in response to an electronic signal representing immediate deployment from the electronic controller 70. Once triggered, the inflator 62 provides an expanding material, such as a gas or gaseous material, to the deployable member 64 causing the deployable member 64 to rapidly expand and fully deploy. For example, the inflator 62 and the deployable member 64 can be configured such that the deployable member 64 fully expands or inflates in a just a few milli-seconds (i.e., 10-50 milli-seconds) after the inflator 62 is triggered by the electronic controller 70.

Consequently, when the vehicle 10′ contacts the fully deployed deployable member 64, the impact forces from the vehicle 10′ are at least partially absorbed by the fully deployed deployable member 64. Further, the fully deployed deployable member 64 transfers a portion of the impact forces to the structural member 50. Since the structural member 50 is fixedly attached to front and rear edge sections of the inner and outer panels 40 and 42 of the door 36, the impacting forces are transmitted through the structural member 50 to the door 36, and further to the A-pillar 20 and the B-pillar 22. As mentioned above, the hinges H of the door 36 are fixed to the A-pillar 20. A latch mechanism of the door 36 fixes the rear end of the door 36 to the B-pillar 22, in the closed orientation. Therefore, significant amounts of impact forces can be transmitted through the fully deployed deployable member 64 to the structural member 50, through the door 36 and to the A-pillar 20 and the B-pillar 22.

### Second Embodiment

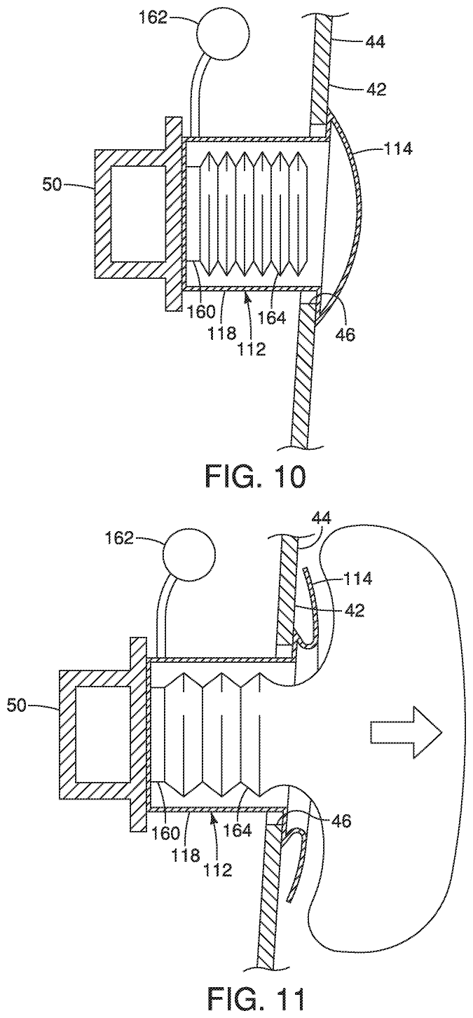

Referring now to FIGS. 10 and 11, a deployable energy absorbing device 112 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

In the second embodiment, the deployable energy absorbing device 12 of the first embodiment is removed from the door 36 and is replaced with the deployable energy absorbing device 112 in the door 36 of the second embodiment.

The deployable energy absorbing device 112 is depicted in FIGS. 10 and 11 installed within the door 36 such that the deployable energy absorbing device 112 is attached to the structural member 50. The door 36 also includes the opening or elongated slot 46 defined by the outer panel 42 of the front door 36.

The deployable energy absorbing device 112 includes a housing 118, an optional base 160, an inflator 162 and a deployable member 164. The housing 118 and the base 160 can be integrally formed, or can be separate elements, with the base 160 being within the housing 118 or outside the housing 118. The base 160 or the housing 118 is configured to fixedly attach to the structural member 50.

The housing 118, as shown in FIG. 10, defines a trim portion 114. With the deployable member 164 in a stowed orientation as in FIG. 10, the trim portion 114 covers the elongated slot 46. Upon deployment of the deployable member 164, the trim portion 114 is configured to split open allowing the deployable member 164 to fully expand and inflate, as shown in FIG. 11. Operation (deployment) of the deployable member 164 via the inflator 162 is identical to the operation of the deployable member 14 via the inflator 62 as described above with respect to FIGS. 7, 8 and 9 in the first embodiment.

### Third Embodiment

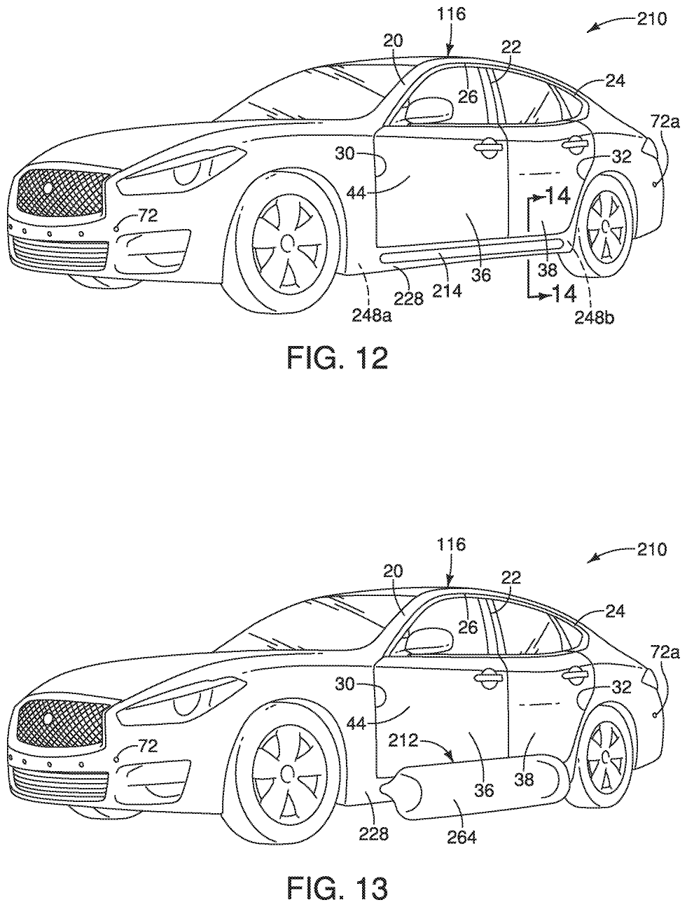

Referring now to FIGS. 12-15, a vehicle 210 having a deployable energy absorbing device 212 and a vehicle body structure 216 in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity.

In the third embodiment as shown in FIGS. 12 and 13, the vehicle body structure 216 of the vehicle 210 includes a sill structure 228 with the deployable energy absorbing device 212 being installed within the sill structure 228.

The vehicle 210 also includes the movement detection sensors 72 and 72a (sonar or radar sensors), the A-pillar 20, the B-pillar 22, the C-pillar 24, the roof rail 26, the front door opening 30, the rear door opening 32, the front door 36 and the rear door 38, as described above with reference to the first embodiment. However, in the third embodiment, the front door 36 does not have an elongated slot or opening and does not include the deployable energy absorbing device 12 of the first embodiment.

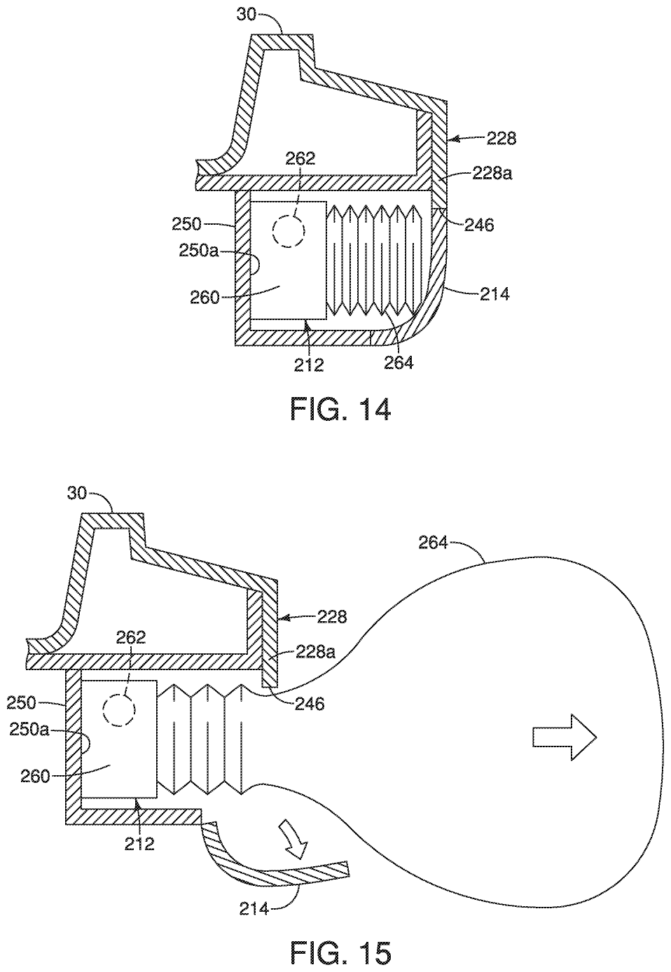

The sill structure 228 of the vehicle 210 is a modified sill structure, as compared with the sill structure 28 of the first embodiment. The sill structure 228 defines an opening or elongated slot 246 that is covered by an exterior trim panel 214. The sill structure 228 further includes a rigid structural member 250 that defines an inboard side of the sill structure 228. The structural member 250 is rigidly fixed via, for example, welding techniques to various structures of the vehicle body structure 216 of the vehicle 210 in a conventional manner. The structural member 250 (a rigid beam) and the exterior trim panel 214 at least partially defines a hollow interior 248 within the sill structure 228, as shown in FIGS. 14 and 15. The deployable energy absorbing device 212 installed within the sill structure 228 and is aligned with the elongated slot 246, as shown in FIGS. 14 and 15. The structural member 250 an upright surface 250a that at least partially defines an interior surface of the hollow interior. The structural member 250 extends from a forward end 248a of the hollow interior 248 of the sill structure 228 to a rearward end 248b of the hollow interior 248 of the sill structure 228.

The elongated slot 246 extends in the vehicle longitudinal direction, and the deployable energy absorbing device 212 has an elongated shape that conforms to the shape of the elongated slot 246 and is aligned with the elongated slot 246 in the stowed orientation. A lateral exterior surface 228a of the sill structure 228 extends in a direction parallel to the vehicle longitudinal direction. Further, the elongated slot 246 (the opening 246) is located beneath the front door opening 30. An inboard side of the deployable energy absorbing device 212 is fixedly attached to upright surface 250a of the structural member 250 (the rigid beam).

The deployable energy absorbing device 212 includes an base 260, an inflator 262 and a deployable member 264. The base 260 is configured to fixedly attach to the structural member 250 via, for example, mechanical fasteners (not shown).

The exterior trim panel 214 is an elongated trim element attached to the sill structure 228 covering the elongated slot 246 and the deployable energy absorbing device 212 such that upon deployment of the deployable member 264 of the deployable energy absorbing device 212, the trim panel 214 breaks away, or pivots downward.

Specifically, with the deployable member 264 in a stowed orientation as in FIG. 14, the trim panel 214 covers the elongated slot 246. Upon deployment of the deployable member 264, the trim panel 214 is configured to open allowing the deployable member 264 to fully expand and inflate, as shown in FIG. 15. Operation (deployment) of the deployable member 264 via the inflator 262 is identical to the operation of the deployable member 14 via the inflator 62 as described above with respect to FIGS. 7, 8 and 9 in the first embodiment.

The various vehicle features and elements are conventional components that are well known in the art. Since such vehicle features and elements are well known in the art, these structures will not be discussed or illustrated in detail herein. Rather, it will be apparent to those skilled in the art from this disclosure that the components can be any type of structure and/or programming that can be used to carry out the present invention.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle equipped with the vehicle with a deployable energy absorbing device. Accordingly, these terms, as utilized to describe the present invention should be interpreted relative to a vehicle equipped with the vehicle with a deployable energy absorbing device.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A vehicle, comprising:
a vehicle body structure defining a vehicle longitudinal direction, having an opening along a lateral exterior side thereof, the opening exposing a hollow interior of the vehicle body structure, and. the vehicle body structure having a structural member that extends parallel to the vehicle longitudinal direction within the hollow interior inboard of the opening; and
an deployable energy absorbing device having a deployable member, the deployable energy absorbing device being supported to the structural member of the vehicle body structure within the hollow interior, the deployable energy absorbing device being concealed within the hollow interior in the stowed orientation, the deployable member extending laterally outward perpendicular to the vehicle longitudinal direction and away from the structural member and a lateral exterior side of the vehicle body structure in a deployed orientation.

2. The vehicle according to claim 1, wherein
the opening along the lateral exterior side is an elongated slot that extends in the vehicle longitudinal direction, and the deployable energy absorbing device has an elongated shape that conforms to the shape of the elongated slot and is aligned with the elongated slot in the stowed orientation.

3. The vehicle according to claim 1, wherein
the deployable member is a metallic inflatable member that includes portions folded in an accordion bellows-like manner.

4. The vehicle according to claim 1, wherein
the lateral exterior surface extends in a direction parallel to the vehicle longitudinal direction.

5. The vehicle according to claim 4, wherein
the opening in the lateral exterior surface is an elongated slot that extends in the vehicle longitudinal direction, and the deployable member of the deployable energy absorbing device has an elongated shape that conforms to the shape of the elongated slot and is aligned with the elongated slot.

6. The vehicle according to claim 1, wherein
the vehicle body structure has a vehicle opening with a door pivotally attached to the vehicle body structure covering the vehicle opening in a closed orientation, the door having an outer panel that defines the lateral exterior side surface and includes the opening, with the hollow interior being defined within the door.

7. The vehicle according to claim 6, wherein
the opening in the outer panel of the door is an elongated slot that extends parallel to the vehicle longitudinal direction, and the deployable member has an elongated shape that conforms to the shape of the elongated slot and is aligned with the elongated slot.

8. The vehicle according to claim 6, wherein
the door includes an inner panel and the outer panel that define the hollow interior, the structural member being a rigid guard beam that extends from a forward end of the door to a rearward end of the door within the hollow interior, the guard beam being rigidly fixed to the forward end of the door and the rearward end of the door.

9. The vehicle according to claim 8, wherein
an inboard side of the deployable energy absorbing device is fixedly attached to the guard beam.

10. The vehicle according to claim 7, further comprising
an elongated trim element attached to the outer door panel covering the elongated slot and the deployable energy absorbing device such that upon deployment of the deployable member the elongated trim element is at least partially released from the outer door panel and the deployable member expands through the elongated slot and laterally away from the vehicle body structure.

11. The vehicle according to claim 1, wherein
the vehicle body structure has sill structure beneath a door opening, the sill structure defining the lateral exterior side surface that includes the opening, with the hollow interior being defined within the sill structure.

12. The vehicle according to claim 11, wherein
the opening in the sill structure is an elongated slot that extends parallel to the vehicle longitudinal direction beneath the door opening, and the deployable member has an elongated shape that conforms to the shape of the elongated slot and is aligned with the elongated slot.

13. The vehicle according to claim 12, wherein
the structural member is a rigid beam of the sill structure has an upright surface that at least partially defines an interior surface of the hollow interior and extends from a forward end of the hollow interior of the sill structure to a rearward end of the hollow interior of the sill structure.

14. The vehicle according to claim 13, wherein
an inboard side of the deployable energy absorbing device is fixedly attached to the rigid beam.

15. The vehicle according to claim 14, further comprising
an elongated trim element attached to the sill structure covering the elongated slot and the deployable energy absorbing device such that upon deployment of the deployable member of the deployable energy absorbing device the elongated trim element is at least partially released from the sill structure and the deployable member expands through the elongated slot and laterally away from the vehicle body structure.

16. The vehicle according to claim 12, wherein
the deployable member is a metallic inflatable member that includes portions folded in an accordion bellows-like manner.

17. The vehicle according to claim 12, wherein
the deployable member is a reinforced fabric airbag.

18. The vehicle according to claim 12, wherein
the deployable member is a deployable thermoplastic energy absorber.

19. The vehicle according to claim 1, wherein
the deployable member is a deployable thermoplastic energy absorber.

20. The vehicle according to claim 1, wherein
the deployable member is a folded rubber-like bladder.
